(19) United States
(12) Patent Application Publication
(10) Pub. No.: US 2003/0016753 A1
(43) Pub. Date: Jan. 23, 2003

(54) Multi-channel video encoding apparatus and method

(76) Inventors: Kyeounsoo Kim, Seoul (KR); Si-Joong Kim, Seoul (KR)

Correspondence Address: NIXON & VANDERHYE P.C., 8th Floor, 1100 North Glebe Road, Arlington, VA, 22201, US

(21) Appl. No.: 10/189,183

(22) Filed: Jul. 5, 2002

(30) Foreign Application Priority Data
Jul. 5, 2001 (KR) 2001-40043

(51) Int. Cl. H04N 7/12

(52) U.S. Cl. 375/240.21; 375/240.28

(57) ABSTRACT

An apparatus and method for encoding multi-channel video signals using a single encoder by a space division technique or a time division technique. In the multi-channel video encoding apparatus, a signal extraction unit extracts synchronous signals and active video data from received video signals. A decimation filter unit spatially decimates the extracted active video data according to the number of channels. A synchronization, unit synchronizes the decimated active video data for channels. An encoding unit encodes the synchronized decimated active video data received from the synchronization unit. This multi-channel video encoding apparatus can independently encode multi-channel video signals at the same time using a single encoder.

### BACKGROUND OF THE INVENTION

1. Field of the Invention

The present invention relates to encoding of video signals, and more particularly, to an apparatus and method of processing multi-channel video signals using a single encoder by a space division method, a time division method, or their hybrid method.

2. Description of the Related Art

In the prior art, when multiple videos for digital video surveillance are received through many channels (cameras), as many video processors as the number of video channels are provided to independently process the video signals for each channel. Accordingly, conventional multi-channel video recorders such as CCTVs are large-scale systems, and provide a low-quality picture as compared to their system volume and include complicated elements for storing and transferring video signals.

In order to solve these problems, methods of storing and transferring video signals by a digital compression technique have recently been developed. Most video signal compression algorithms for video surveillance such as H.263, MJPEG, MPEG-4 developed up to now have been implemented in software. However, this software depends on general-purpose computing power, hence a system adopting this software is expensive and significantly big, and also unstable and unable to be processed in real-time due to an excessive load of things to be processed. Thus, video surveillance systems have been developed as stand-alone type systems based on hardware having embedded operating system. However, these standalone type video surveillance systems also adopt an MPEG-1 or MPEG-2 compression algorithm. Systems using a single MPEG-1 video encoder are not suitable for processing multiple video signals because the resolution of a screen is just 352×240 (the lower resolution of a screen than 352×240 is not used in real application for video recorder). Systems adopting an MPEG-2 video encoder can process a video signal with a resolution four times higher screen resolution than that of an MPEG-1 compression algorithm, thus having no difficulty in processing four channels of 352×240 video signals. However, multiple video signals having NTSC/PAL full resolution (720×480) cannot be simultaneously compressed by a single general-purpose MPEG-2 video encoder. Thus, systems require as many video encoders as the number of received video signals in order to simultaneously encode multiple video signals, and also require a lot of extra hardware such as a filter, a buffer or a frame synchronization circuit. This results in expensive, significantly bulky systems.

### SUMMARY OF THE INVENTION

To solve the above-described problems, it is an objective for the presented invention to provide a method and apparatus for processing multiple input video signals using a single encoder on the basis of a time division system, a space division system, or their hybrid system.

In order to achieve the above object, the presented invention provides a multi-channel video encoding apparatus including a signal extraction unit, a decimation filter unit, a synchronization unit and an encoding unit. The signal extraction unit extracts synchronous signals and active video data from received video signals. The decimation filter unit spatially decimates the extracted active video data according to the number of channels. The synchronization unit synchronizes the decimated active video data for channels. The encoding unit encodes the synchronized decimated active video data received from the synchronization unit.

In a multi-channel video encoding apparatus adopting a time division system, a signal extraction unit extracts synchronous signals and active video data from received video signals. A decimation filter unit spatially decimates the extracted active video data according to the number of channels. A synchronization unit stores the decimated active video data for channels received from the decimation filter unit and sequentially outputs the stored independent video data in synchronization with the synchronous signal of the last-received video data. An encoding unit sequentially encodes the independent video data for channels received from the synchronization unit, to produce bitstreams for channels. The multi-channel video encoding apparatus adopting a time division system can further include an output unit for outputting the bitstreams for channels produced by the encoding unit, without change, or combining the bitstreams for channels into a single bitstream and outputting the single bitstream.

In a multi-channel video encoding apparatus adopting a space division system, a signal extraction unit extracts synchronous signals and active video data from received video signals. A decimation filter unit spatially decimates the extracted active video data according to the number of channels. A synchronization unit stores the decimated active video data for channels received from the decimation filter unit and combines the stored independent video data into a single video signal in synchronization with the synchronous signal of the last-received video data. An encoding unit encodes the single combined video signal at one time like a single channel video signal is encoded, to produce a single bitstream. The encoding unit includes as many variable length encoders and as many bitstream buffers as the number of channels, the variable length encoders and bitstream buffers for independently encoding the active video data for channels on the basis of the boundary information between the video signals for channels and outputting independent bitstreams for channels.

The multi-channel video encoding apparatus adopting a space division system further includes an output unit for outputting the bitstreams for channels produced by the encoding unit, without change, or combining the bitstreams for channels into a single bitstream and outputting the single bitstream.

The multi-channel video encoding apparatus adopting a space division system further includes a bitstream distributor for extracting bitstreams for channels on the basis of the boundary information between channels included in a single bitstream produced by the encoding unit and outputting the bitstreams for channels.

In the multi-channel video encoding apparatus adopting a space division system, distortion of a picture is prevented by obtaining a differential picture between macroblocks through comparison of corresponding channel video signals on the basis of the boundary information between channels included in the single bitstream produced by the encoding unit. Distortion of a picture is also prevented by limiting the motion search area to the picture for an individual channel video signal in order not to search for a motion by crossing over the boundaries of pictures for video signals during motion estimation, on the basis of the boundary information between channels included in a single bitstream produced by the encoding unit.

In a multi-channel video encoding method according to the present invention, synchronous signals and active video data are extracted from received video signals. The extracted active video data is spatially decimated according to the number of channels to be multiprocessed. The decimated active video data for channels are synchronized and serialized. The decimated active video data for channels are sequentially encoded.

For more scalable and flexible adaptation of the present invention, the hybrid technique of space and time division multiplexing is also presented. While space division technique is suitable for the applications requiring low resolution and multiple channels, time division technique is appropriate for the high resolution and low frame rate. According to surveillance environments, hybrid technique is selectively used with a single video encoder.

### BRIEF DESCRIPTION OF THE DRAWINGS

The above object and advantages of the present invention will become more apparent by describing in detail preferred embodiments thereof with reference to the attached drawings in which:

FIG. 1 is a conceptual view of multi-channel (4-channel) video signal encoding using a time division system and a space division system;

FIG. 2 is a block diagram of the fundamental configuration of a multi-channel video encoding apparatus according to the present invention;

FIG. 3 shows the concept of time division encoding of multi-channel video signals;

FIG. 4 is a block diagram of a multi-channel video encoding apparatus adopting a time division system, according to a preferred embodiment of the present invention;

FIG. 5 shows the concept of space division encoding of multi-channel video signals;

FIG. 6 is a block diagram of a multi-channel video encoding apparatus adopting a space division system, according to a preferred embodiment of the present invention;

FIG. 7 shows an example of slice boundaries of divided pictures, the slice boundaries formed to show multi-channel video signals as a single picture; and

FIG. 8 is a block diagram of a simplified multi-channel video encoding apparatus adopting a space division system, according to a preferred embodiment of the present invention.

FIG. 9 is a block diagram of a hybrid multi-channel video encoding apparatus adopting both space and time division system, according to a preferred embodiment of the presented invention.

### DETAILED DESCRIPTION OF THE INVENTION

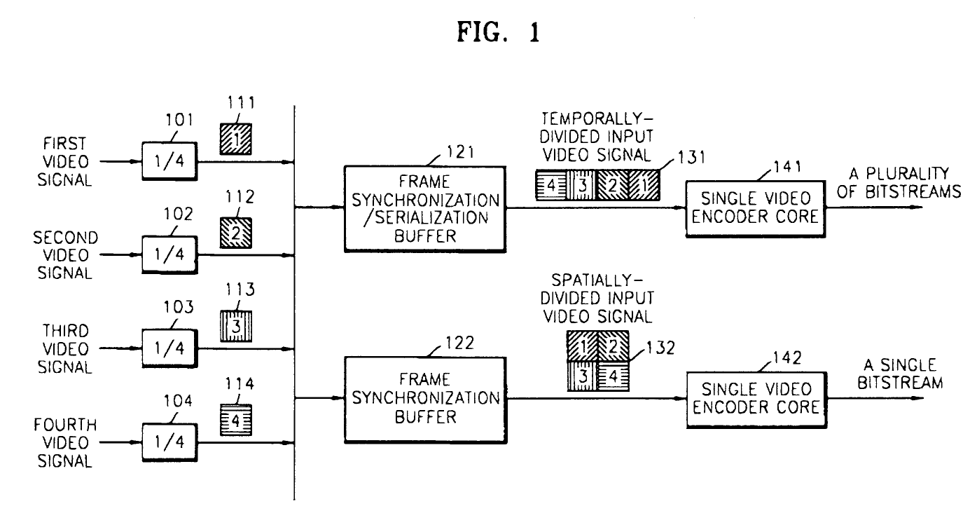

Referring to FIG. 1, with four video signal channels provided, when four video signals are input to 1/4 decimation filters 101, 102, 103 and 104 for four channels, the 1/4 decimation filters 101, 102, 103 and 104 decimate the video signals to a quarter of their image sizes. The decimated video signals are input to a frame synchronization/serialization buffer 121 to be sequentially processed or input to a frame synchronization buffer 122 to be formed into a single picture form. The frame synchronization/serialization buffer 121 for a time division system individually stores the decimated video signals and outputs them in the form of a temporally-divided input video signal 131. The temporally-divided input video signal is encoded by a single video encoder core 141, in which four encoding processes are performed for four channels. Consequently, four independently-encoded bitstreams are sequentially output. On the other hand, the frame synchronization buffer 122 for a space division system outputs a spatially-divided input video signal 132. The spatially-divided input video signal 132 is input to a single video encoder core 142 and encoded at one time, resulting in a single bitstream.

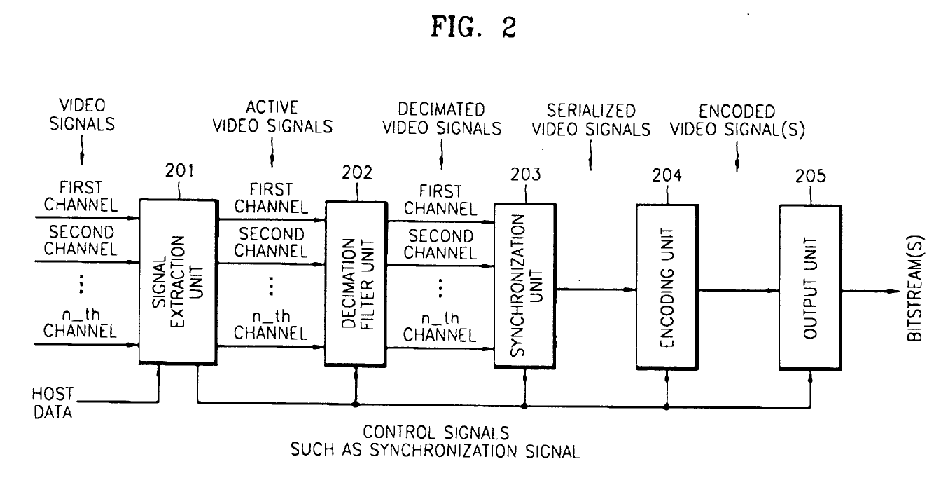

FIG. 2 is a block diagram showing the fundamental configuration of a multi-channel video encoding apparatus according to the present invention. A video signal received from a camera via n channels (where n denotes a positive integer) is composed of 858 times 525 pixels on the basis of National Television Standards Committee (NTSC) and composed of 858 times 625 pixels on the basis of Phase Alternation Line (PAL). The NTSC video signal includes a blank area and an active area of 720 times 480 pixels, and the PAL video signal includes a blank area and an active area of 720 times 576 pixels. Referring to FIG. 2, the video signal received from a camera is an analog signal. The analog video signal is converted into a digital signal and CCIR601/656 formatted by a NTSC/PAL decoder and then fed into a signal extraction unit 201 through n channels. The signal extraction unit 201 extracts active video signals from the received n-channel video signals by demarcating active data on the base of header data composed of start active video (SAV) and end active video (EAV), and produces a synchronization signal. The signal extraction unit 201 also produces an encoding clock on the basis of the synchronization signal, and receives host data to obtain control signals such as a single/multi-channel selection signal, a coding parameter or a single/multi-channel coding clock. These control signals are supplied to each of the elements of the multi-channel video encoding apparatus according to the present invention. The active video signals output from the signal extraction unit 201 are fed into a decimation filter unit 202 and decimated into 1/n-sized video signals, which are then output to a synchronization unit 203.

The synchronization unit 203 provides the received n-channel video signals to an encoding unit 204 in synchronization with the last-received signal among the video signals for n channels. For time division multi-channel video encoding, the synchronization unit 203 sequentially provides the n independent video signals, the number of which is the same as the number of channels, to the encoding unit 204. For space division multi-channel video encoding, the synchronization unit 203 combines the n decimated video signals into a single video signal and provides the single combined video signal to the encoding unit 204.

The encoding unit 204 receives the n sequential video signals or the single combined video signal from the synchronization unit 203, encodes them and outputs the result of the encoding to an output unit 205. For multi-channel encoding by time division, the encoding unit 204 encodes the received video signals into n independent bitstreams. For multi-channel encoding by space division, the encoding unit 204 encodes the received video signals into a single bitstream.

The output unit 205 generally outputs the n independent bitstreams received from the encoding unit 204, without change, or outputs the single bitstream received from the encoding unit 204, without change. As needed, the output unit 205 converts the n independent bitstreams into a single combined bitstream and outputs the single combined bitstream to the outside, or vice versa.

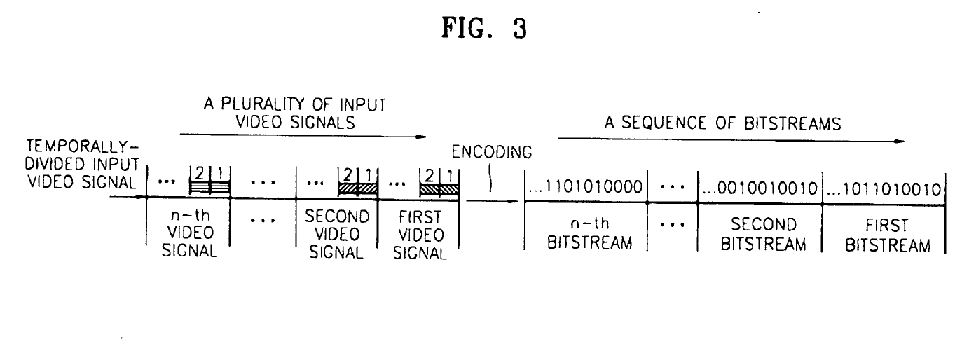

FIG. 3 shows the concept of time division encoding of multi-channel video signals. Referring to FIGS. 2 and 3, in order to encode video signals supplied through multiple channels in a time division method, the encoding unit 204 receives a plurality of independent video signals for channels and independently encodes them to produce a sequence of bitstreams.

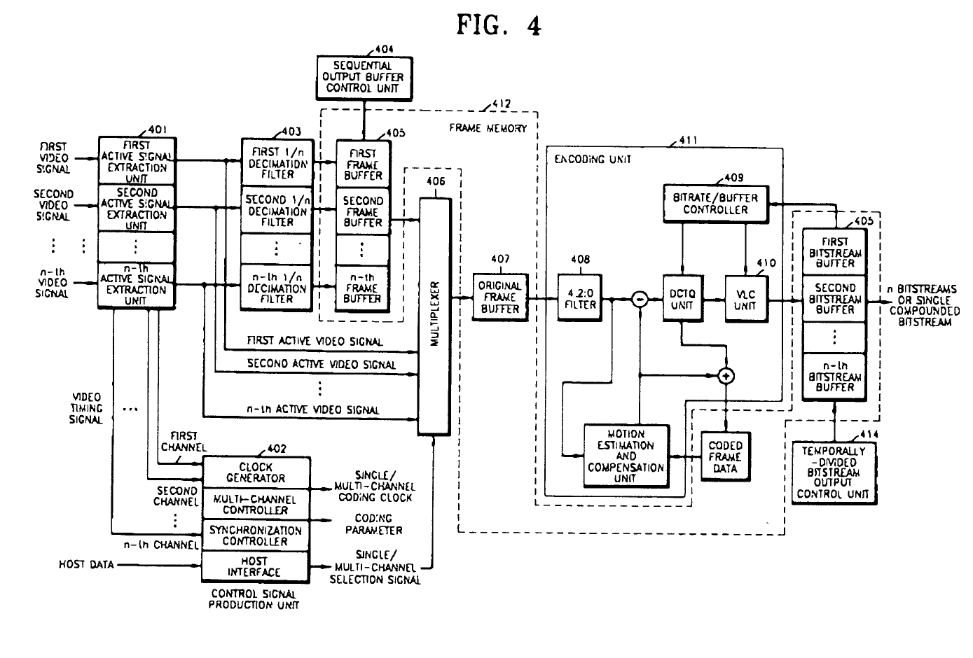

FIG. 4 is a block diagram of a multi-channel video encoding apparatus adopting a time division system, according to the present invention. Referring to FIG. 4, video signals are input to an active signal extraction unit 401 through n channels (where n denotes an arbitrary positive integer). The active signal extraction unit 401 extracts active video signals from the received video signals and provides the active video signals to a 1/n decimation filtering unit 403. The active signal extraction unit 401 also produces video timing signals and supplies them to a control signal production unit 402, which includes a clock generator, a multi-channel controller, a sync controller and a host interface. The control signal production unit 402 produces control signals, such as, a single/multi-channel coding clock, a coding parameter and a single/multi-channel selection signal, on the basis of received host data, and outputs the received video timing signals and the produced control signals to the elements of the multi-channel video encoding apparatus according to the present invention. The 1/n decimation filtering unit 403 decimates the received active video signals for channels so that they produce 1/n-sized pictures, and supplies decimated active video signals to a frame buffer 405, which is composed of independent buffers for channels.

Video signals received through channels, which are generally interlace-scanned video signals, are CCIR601/656 formatted by a NTSC/PAL decoder before being fed into a multi-channel video encoding apparatus. That is, a video signal is input in units of even fields or odd fields, hence it can be decimated into a video signal, which produces a frame image or a field image.

When a video signal is decimated into a frame image signal, decimation must be performed after a field, and first image data on the j-th line of the picture produced from the video signal are input. Here, j denotes half the number of decimation filter taps.

When a video signal is decimated into a field image signal, decimation is performed after first image data on the k-th line of a picture produced from the video signal is input. Here, k denotes the number of filter taps.

A decimation filter unit for n channels, where n denotes a positive integer, reduces the size of images of a received video signal into 1/n×1/n. Generally, 7-tap filters and 6-tap filters are used. A 1/4 decimation filter filters one out of two pixels in both horizontal and vertical directions to halve the number of pixels in both horizontal and vertical directions, thereby producing four 1/4-sized pictures. A 1/9 decimation filter filters one out of three pixels in both horizontal and vertical directions to reduce the number of pixels in both horizontal and vertical directions to a third, thereby producing nine 1/9-sized pictures. A 1/16 decimation filter produces sixteen 1/16-sized pictures in the same way as the 1/4 and 1/9 decimation filters do. To achieve the above-described decimation, a decimation filter first requires a buffer for storing as many data as the number of filter taps and then filters pixels in the horizontal direction. Similar to the horizontal-direction filtering, the decimation filter first stores as many image lines as the number of filter taps in a memory and then filters pixels in the vertical direction.

The frame buffer unit 405 sequentially supply stored frame data to a multiplexer 406 in synchronization with the last-received frame data, under the control of a sequential output buffer control unit 404. The coding clock produced based on the video timing signals for channels generated by the active signal extraction unit 401 is used as a reference clock to encode n successive video signals. That is, the frame buffer unit 405 stores the frame data in a sequence how frame data for channels are received, and output the sequentially-stored frame data in synchronization with the last-received frame data.

While the active video signals extracted by the active signal extraction unit 401 are supplied to the 1/n decimation filter 403, they are also supplied to the multiplexer 406 that selects one from (n+1) received signals on the basis of the single/multi-channel selection signal. That is, when the multiplexer 406 selects a particular input channel by the help of the control signal production unit 402, single channel encoding of an NTSC/PAL image is performed with respect to the selected single channel signal. When the multiplexer 406 selects multiple channels by the help of the control signal production unit 402, time division encoding of n 1/n-sized images is performed with respect to the selected multiple channel signals. That is, the multiplexer 406 is provided to selectively perform single channel encoding or multi-channel encoding.

A signal selected by the multiplexer 406 is supplied to an original frame buffer 407. The video signal supplied to and stored in the original frame buffer 407 is supplied to an encoding unit 411 and undergoes encoding therein. The encoding unit 411 includes a 4:2:0 filter 408, a motion estimation and compensation unit, a discrete cosine transform quantization (DCTQ) unit, a variable length coding (VLC) unit 410 and a bitrate/buffer controller 409. The 4:2:0 filter 408 halves the amount of color data. The motion estimation and compensation unit reduces temporal redundant information by estimating and compensating for the motion between adjacent pictures. The DCTQ unit removes spatial redundant information using a frequency conversion method. The bitrate/buffer controller 409 controls the encoding speed, that is, the bitrate, and a bitstream buffer unit 413 for storing encoded bitstreams. Since the temporally-divided input frame data, and bitstreams encoded in synchronization with the encoding clock, must individually undergo bitrate/buffer control at intervals of time-division time slots, the bitstream buffer unit 413 should be composed of n independent bitstream buffers.

Bitstreams into which the temporally-divided input frame data is encoded with respect to channels are stored in the bitstream buffer unit 413. A temporally-divided bitstream output controller 414 controls the bitstream buffer unit 413 so that its stored bitstreams are output either as n bitstreams, the number of which is the number of channels, or as a single compounded bitstream. Here, the frame buffer unit 405, the original frame buffer 407, an encoded frame, and the bitstream buffer unit 413 are included in a frame memory 412.

Video encoding for time division multiprocessing will now be described with reference to FIGS. 3 and 4. In time division video encoding, n input images are decimated into 1/n-sized input images and stored in an input buffer, and the stored images are arrayed in synchronization with the last-received image and sequentially fed into the encoding unit 411. The encoding unit 411 must process each of the received 1/n-sized images within a 1/n duration of the total duration for processing a full resolution image.

The above-described time division encoding by the encoding unit 411 results in n different bitstreams output one after another, as shown in FIG. 3. Here, extra time produced by independently processing n bitstreams must not exceed the input period of a full resolution NTSC/PAL image. Referring to FIG. 4, the time of access of the encoding unit 411 to a frame memory 412 depends on how the encoding unit accesses the frame memory. Original frame data is stored in the frame memory 412 one line at a time, and the stored original frame data is read from the frame memory 412 one macroblock (MB) at a time in order to filter and encode the original frame data into 4:2:0 data. Coded frame data is written to and read by the frame memory 412 on a macroblock-by-microblock basis. Bitstream data is stored in the bitstream buffer unit 413 one bitstream at a time, and output to the outside under the control of a buffer control algorithm. In order that the encoding unit 411 can process n images with an 1/n resolution of a full resolution as well as a full resolution image, the access time for storing data in the original frame buffer must be adjusted to an 1/n-sized image so that n 1/n-resolution input images are independently processed. That is, compared to an encoding unit for processing only one image, the encoding unit 411 for n input channel images requires an increased frequency of random accesses since the line length of each image is n^{1/2}.

The bitstream buffer unit 413 stores bitstreams produced from 1/n-sized images in n independent buffers and outputs them by buffer control for each bitstream. Since coded frame data is accessed on a macroblock-by-microblock basis, there is no increase in the access time due to random access. The frame buffer unit 405 first receives and stores n frames and then output them in series in synchronization with the last-received frame. The multi-channel video encoding apparatus of FIG. 4 is different from a general-purpose single-channel video encoding apparatus in that it requires the frame buffer unit for synchronization and serialization and the extraction unit and the decimation filter unit both for multi-channel image processing, and in that it stores the original image and independently controls a bitstream buffer.

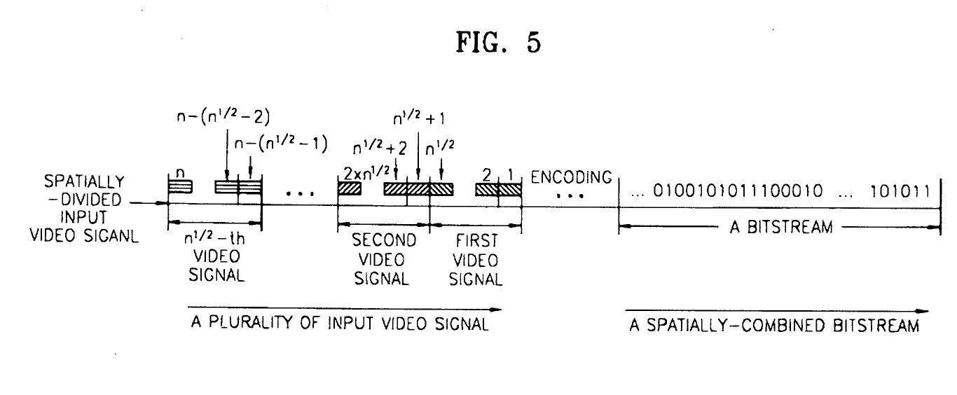

FIG. 5 shows the concept of space division encoding of multi-channel video signals. In space division encoding, n input multi-channel images are decimated into 1/n-sized images, and the decimated images are integrated into a full resolution image. When an encoding unit receives the full resolution image composed of n 1/n-sized images, it considers the spatially-divided input image as a single picture. That is, the full resolution image composed of n 1/n-sized images, that is, the spatially-divided input image, can be processed by a single encoding unit without needing n encoding units.

FIG. 5 conceptually shows space division multiprocessing sequence in which an encoding unit processes a spatially-divided input video signal from left to right and from up to down. A compressed bitstream as shown in FIG. 5 is not suitable to independently store and transmit the video signals for channels integrated into the compressed bitstream. This requires an extra process for producing independent bitstreams for n pictures. If there are n input channels, the number of pictures on one screen in each of the horizontal and vertical directions is n^{1/2}. The n^{1/2} pictures are encoded to be combined, thereby obtaining a single bitstream. This combined bitstream can be broken down into n individual bitstreams for channels by decoding. In this case, the vbv_delay and quantization parameter of individual bitstreams for channels are calculated again with respect to the n input images and added to the head of each of the individual bitstreams.

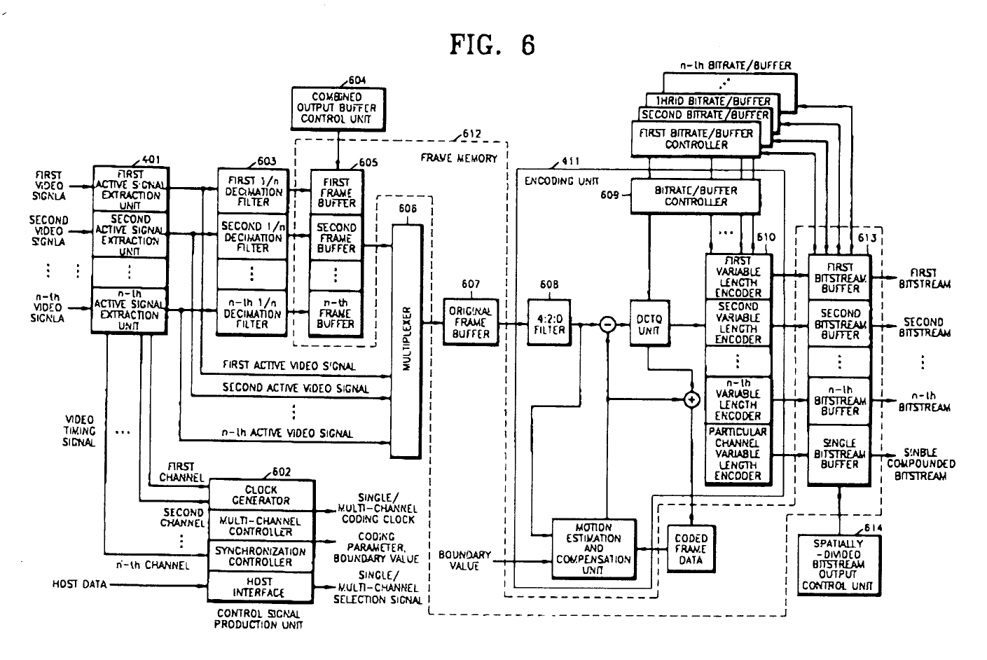

FIG. 6 is a block diagram of a multi-channel video encoding apparatus for space division multiprocessing, according to a preferred embodiment of the present invention. Referring to FIG. 6, an active signal extraction unit 601, a 1/n decimation filter unit 603, a control signal production unit 602, a frame buffer unit 605, a multiplexer 606, an original frame buffer 607, a 4:2:0 filter 608 and an encoding unit 611 have the same functions as the corresponding elements of the multi-channel video encoding apparatus for time division multiprocessing of FIG. 4. However, in contrast with the multi-channel video encoding apparatus of FIG. 4, the control signal production unit 602, including a clock generator, a multi-channel controller, a synch controller and a host interface, produces the boundary value of each of the video signals for channels. Upon encoding video signals combined into one picture, the boundary values of the video signals are used to independently encode the combined video signals for adjacent pictures in order to process different images on the boundary of adjacent video signal pictures. Another different portion is that a VLC unit 610 and a bitstream buffer unit 613 are composed of as many variable length coders and bitstream buffers as the number of channels, respectively, in order to ensure the independency between a plurality of output bitstreams of video signals for channels. Still another different portion is that a bitrate/buffer control unit 609 is composed of as many bitrate/buffer controllers as the number of channels in order to perform independent bitrate/buffer control operations with respect to the individual image signals.

The VLC unit 610 must include a particular channel variable length coder for encoding a single NTSC/PAL video signal with respect to a particular channel. With the particular channel variable length coder provided, a single bitstream composed of n pictures can be output in the same manner as particular single channel video encoding. A bitstream buffer and a controller must be additionally provided in order to produce a single combined bitstream as well as n independent bitstreams. A combined output buffer control unit 604 reads video signals from the frame buffer unit 605 in synchronization with the last-received video signal among the n channel video signals and spatially rearranges them. Then, the frame buffer unit 605 outputs the spatially-rearranged video signals to the multiplexer 606. A spatially-divided bitstream output control unit 614 controls the frame buffer unit 613, composed of first through n-th bitstream buffers and a single bitstream buffer, to output either first through n-th bitstreams or a single combined bitstream as occasion demands. Similar to the multi-channel video encoding apparatus of FIG. 4, the frame buffer unit 605, the original frame buffer 607, a coded frame, and the bitstream buffer unit 613 exist within a frame memory 612.

A method of encoding a video signal into which video signals for different channels are combined like a single channel video signal, into a single bitstream and separating the single bitstream into compressed bitstreams for multi-channel video signals will now be described in detail. Here, the combined video signal corresponds to a picture composed of different pictures. In order to separate the single encoded bitstream into many encoded bitstreams for video signals on individual channels, information representing the boundary between adjacent pictures must be included in the bitstream for the combined picture. The component pictures can be distinguished from each other by referring to the slice_start_code (SSC) on an MPEG-2 bitstream. The size of the component pictures depends on 4-division, 9-division or 16-division, and the slice boundary is provided at the horizontal start point of each of the component pictures. In picture division in four, an NTSC/PAL input picture is composed of 720 pixels in the horizontal direction and thus it is composed of 45 macroblocks (MB). When the 45 macroblocks are divided in two in the horizontal direction to perform 4-division, they are not divided into two parts having the identical number of macroblocks. Thus, a video encoding parameter can be set as the two following approaches.

In the first approach for picture division in four, the number of macroblocks in the horizontal direction is set to be 44 as in formula (hor_mb_size=44), the 44 macroblocks corresponding to 704 pixels, and the number of macroblocks in the vertical direction is set to be 30 as in formula (ver_mb_size=30), the 30 macroblocks corresponding to 480 pixels. The horizontal and vertical offset representing an encoding start position is set to be (0, 0) as in formula: hor_offset=0, ver_offset=0.

In the second approach for picture division in four, the number of macroblocks in the horizontal direction is set to be 44 as in formula (hor_mb_size=44), the 44 macroblocks corresponding to 704 pixels, and the number of macroblocks in the vertical direction is set to be 30 as in formula (ver_mb_size=30), the 30 macroblocks corresponding to 480 pixels. The horizontal and vertical offset representing an encoding start position is set to be (8, 0) as in formula: hor_offset=8, ver_offset=0.

In picture division in 9, the macroblocks of an NTSC/PAL input picture can be exactly divided into 3 equal groups in both horizontal and vertical directions. Consequently, there is no need to reduce the number of macroblocks in both horizontal and vertical directions. The horizontal and vertical offsets can be set to be 0 and 0.

In picture division in 16, the macroblocks of an NTSC/PAL input picture in the horizontal direction can be divided into four equal groups each having 11 macroblocks. However, the 30 macroblocks in the vertical direction are reduced to 28 macroblocks so that they are divided into 4 equal groups each having 7 macroblocks. Alternatively, the vertical offset representing the vertical encoding start position can be set to be 8.

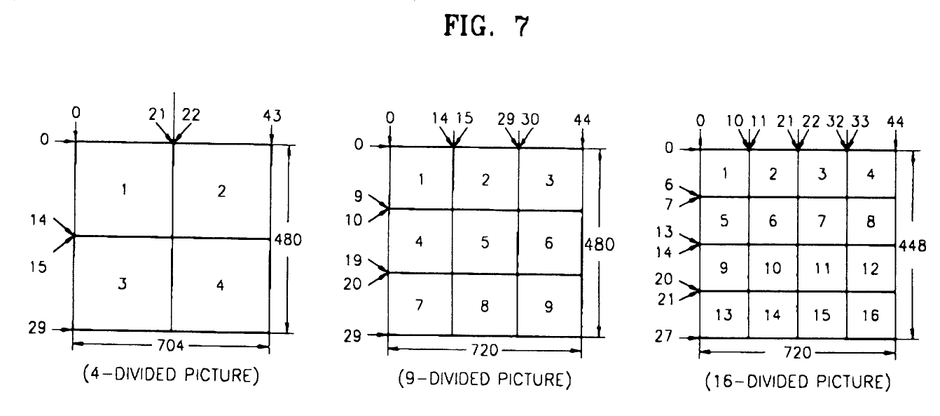

Accordingly, the sizes of the entire pictures practically encoded in cases of 4-division, 9-division and 16-division techniques are 704×480, 720×480 and 720×448, respectively. The sizes of the component pictures of the practically encoded picture in cases of 4-division, 9-division and 16-division techniques are 352×240, 240×160 and 180×112, respectively. The boundaries of the component pictures of a 4-division picture, a 9-division picture and a 16-division picture are shown in FIG. 7.

FIG. 7 shows an example of the slice boundaries formed when a picture for multi-channel video signals is divided in such a way that it looks like a single picture. The reason why a picture is divided into slices is to prevent errors from being transferred between slices while differential pulse code modulation (DPCM) is performed by intra-coding a macroblock at a point of time when slicing starts. Here, DPCM is differential encoding of the same kind of data, and intracoding is encoding of a picture using only its own information. If one line of a picture is encoded into a slice, when an error occurs during the encoding, propagation of the error can only be limited to the range of the single slice. A multi-channel video encoding apparatus according to the present invention simultaneously encodes many independent pictures into a single bitstream and divides the single encoded bitstream into many independent bitstreams. This requires a demarcation of the boundaries between adjacent independent pictures. To do this, a single bitstream is produced, and many individual bitstreams are formed using slice_start codes (SSC) included in the single bitstream. As shown in FIG. 7, in case that a single big picture is composed of many small pictures, if it is divided into small pictures each composed of a number of macroblocks, the macroblock being the minimum unit for encoding, the micro-blocks of the single picture are not divided into equal groups. Therefore, the sizes of encoded pictures may not be the same.

When many slices exist on one line, the macroblock_address_increment (MAI) at the starting point of a new slice is a value representing the number of macroblocks counted from the starting point of the line. However, in order that the slices are considered to be independent bitstreams, the MAI must be set to be 1. That is, a VLC must change the MAI when it produces a new bitstream.

As shown in FIG. 7, the entire picture is composed of many small pictures, hence an encoding unit must estimate a motion between unmatching pictures. This may degrade the efficiency of encoding and even distort the entire picture. The present invention can prevent errors from being spatially propagated, by inserting an SSC into the boundary of adjacent small. The present invention also can prevent distortion of the entire picture by obtaining the differential image between macroblocks through the comparison of matching pictures. The present invention limits a search area to a small picture in order to prevent an encoding unit in its motion estimation processing from crossing over the boundaries of adjacent pictures, so that a wrong picture searching is prevented during the motion estimation between adjacent small pictures. Accordingly, the search range of a motion is limited based on the boundary value of adjacent small pictures shown in FIG. 7.

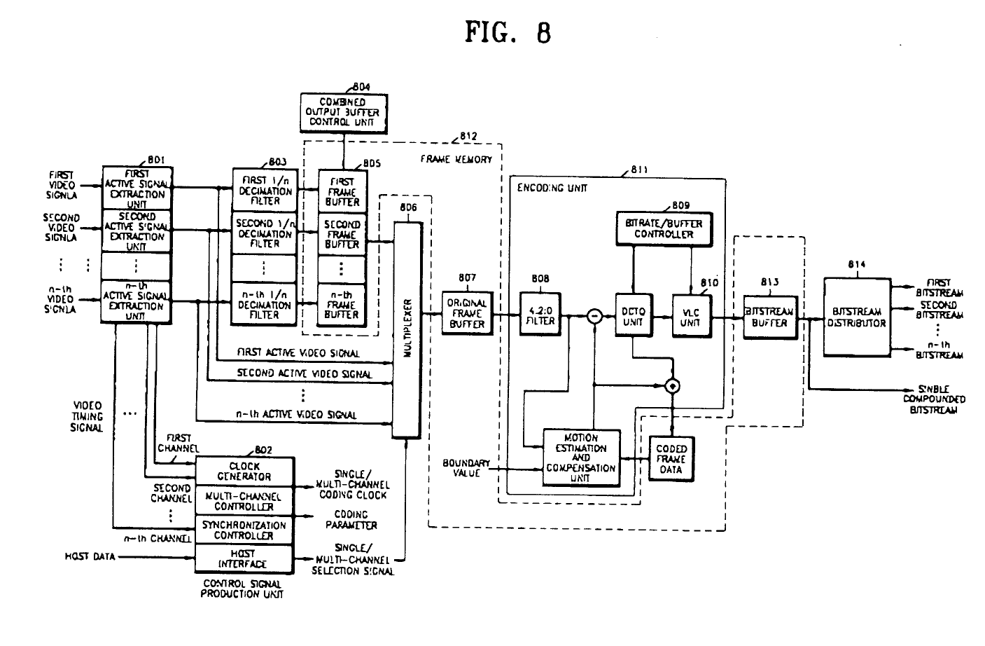

FIG. 8 is a block diagram of a simplified video signal encoder for space division multiprocessing, according to a preferred embodiment of the present invention. Elements 801 through 813 have the same functions as their corresponding elements of FIG. 6 except that the bitrate/buffer control unit 809, the VLC unit 810 and the bitstream buffer 813 are required one by one because the video encoding apparatus of FIG. 8 produces only a single encoded bitstream and divides the single bitstream into individual bitstreams for channels using a bitstream distributor 814. That is, the multi-channel video encoding apparatus of FIG. 8 is the same as a general video encoder except that it has the bitstream distributor 814 at its output side. The single encoded bitstream must have information required to divide the single bitstream into individual bitstreams for channels. Multi-channel videos are spatially reduced to 1/n sizes and then arranged in the first, second, third and fourth quadrants. Then, the arranged multi-channel videos are encoded at one time like a single NTSC/PAL video is encoded, resulting in a single bitstream. The output bitstream is decoded to display the original video. In this case, the bitstream distributor 84 is not needed. However, if the single encoded bitstream includes information on the boundary values of pictures for channels, division of the single bitstream is possible. Here, a SSC is added as a boundary value. At every SSC, the VLC code with respect to an MAI is decoded to plant an MBI VLC code of 1 instead of the original MAI VLC code value. At this moment, byte arrangement of the code must be redone.

When a video signal is encoded at a constant bit rate (CBR), the bitrate/buffer control unit 809 changes a quantization parameter upon occasion according to the state of the bitstream buffer 813 in order to constantly maintain the bit amount to be encoded. In this way, the bitrate/buffer control unit 809 controls the amount of bits output from the encoding unit 811. In order to output independent bitstreams, independent bitstream buffers must be provided so that the bitrate/buffer control unit 809 can perform independent buffer control operations. Accordingly, the bitrate/buffer control unit must pass a quantization parameter to a DCTQ unit so that the DCTQ unit performs a quantization algorithm. The bitrate/buffer control unit 809 must also add a vbv_delay code to the picture head of each of the bitstreams to be output. This means that the bitrate/buffer control unit 809 must recognize both the states of the bitstream buffers and the number of bits generated. Therefore, the multi-channel video encoding apparatus of FIG. 8 must include n variable length coders, n bitrate/buffer controllers and n bitstream buffers, the number of which is the same as the number of channels, similar to the multi-channel video encoding apparatus of FIG. 6. Thus, CBR video encoding cannot be achieved by the multi-channel video encoding apparatus of FIG. 8.

However, variable bit rate encoding can be achieved in the multi-channel video encoding apparatus of FIG. 8 in which, when a new picture starts at the boundary while data on a line is encoded, the data on the next line on the same picture is encoded with reference to the SSC in order to output bitstreams corresponding to small pictures. That is, the MAI at the starting point of a new picture is set to be 1, and the SSC (Vertical_position) at the starting point of each picture is set to be 1.

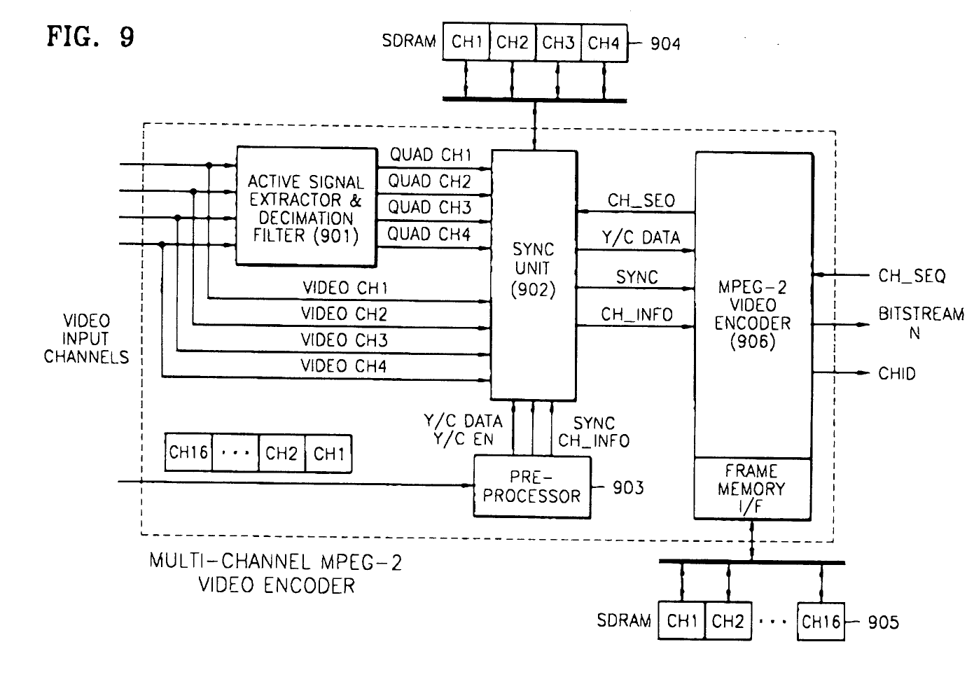

FIG. 9 is a block diagram of a hybrid multi-channel video encoding apparatus adopting both space and time division multiplexing techniques. This diagram covers 4-channel space and time division multiplexing using external SDRAMs (904). When 16-channel synchronized and frame switched serial videos are provided to preprocessor (903) from the outside of the encoder, the presented multi-channel encoder generates 16 different bitstreams along with each channel information using external SDRAMs (905).

Referring to FIG. 9, 901 takes roles to active signal extraction and decimation filtering in FIG. 2. 902 has the same functions as synchronization unit in FIG. 2. In 903, the channel information of the serial videos is inserted together with the synchronization signals. 906 supports channel independent bitstream generation for space and time division multiplexing.Consequently, a multi-channel video encoding apparatus according to the present invention can encode a single NTSC/PAL picture at a constant bit rate or at a variable bit rate. Multi-channel pictures can be simultaneously encoded only at a variable bit rate by the simplified multi-channel video encoding apparatus of FIG. 8.

The above-described embodiments of the present invention can be written as computer programs and realized in general-purpose digital computers by reading the programs from computer readable media. The media include storage media such as magnetic storage media (for example, ROMs, floppy discs, hard discs, etc.), optical reading media (for example, CD-ROMs, DVD, etc.) and a carrier wave (for example, Internet).

While this invention has been particularly shown and described with reference to preferred embodiments thereof, it will be understood by those skilled in the art that various changes in form and details may be made therein without departing from the spirit and scope of the invention as defined by the appended claims. Therefore, the disclosed embodiments should be construed in a descriptive sense only and not for the purpose of limitation of the present invention. It is also to be understood that the scope of the present invention is not set fourth in the foregoing descriptions but in the appended claims, and that all different things are included within the scope of the present invention.

In contrast with an existing encoding apparatus in which as many video encoders as the number of video signal channels are required in order to independently encode a plurality of input video signals at the same time, a multi-channel video encoding apparatus according to the present invention can encode multi-channel video signals using a single encoder. In addition, a multi-channel video encoding apparatus according to the present invention saves the cost of encoding several video signals and can be simply equipped.

What is claimed is:

1. A multi-channel video encoding apparatus comprising:
a signal extraction unit for extracting synchronous signals and active video data from received video signals;
a decimation filter unit for spatially decimating the extracted active video data according to the number of channels;
a synchronization unit for synchronizing the decimated active video data for channels; and
an encoding unit for encoding the synchronized decimated active video data received from the synchronization unit.

2. A multi-channel video encoding apparatus adopting a time division system, the apparatus comprising:
a signal extraction unit for extracting synchronous signals and active video data from received video signals;
a decimation filter unit for spatially decimating the extracted active video data according to the number of channels;
a synchronization unit for storing the decimated active video data for channels received from the decimation filter unit and sequentially outputting the stored independent video data in synchronization with the synchronous signal of the last-received video data; and
an encoding unit for sequentially encoding the independent video data for channels received from the synchronization unit, to produce bitstreams for channels.

3. The multi-channel video encoding apparatus adopting a time division system of claim 2, further comprising an output unit for outputting the bitstreams for channels produced by the encoding unit, without change, or combining the bitstreams for channels into a single bitstream and outputting the single bitstream.

4. A multi-channel video encoding apparatus adopting a space division system, the apparatus comprising:
a signal extraction unit for extracting synchronous signals and active video data from received video signals;
a decimation filter unit for spatially decimating the extracted active video data according to the number of channels;
a synchronization unit for storing the decimated active video data for channels received from the decimation filter unit and combining the stored independent video data into a single video signal in synchronization with the synchronous signal of the last-received video data; and
an encoding unit for encoding the single combined video signal at one time like a single channel video signal is encoded, to produce a single bitstream.

5. The multi-channel video encoding apparatus adopting a space division system of claim 4, wherein the encoding unit comprises as many variable length encoders and as many bitstream buffers as the number of channels, the variable length encoders and bitstream buffers for independently encoding the active video data for channels on the basis of the boundary information between the video signals for channels and outputting independent bitstreams for channels.

6. The multi-channel video encoding apparatus adopting a space division system of claim 5, further comprising an output unit for outputting the bitstreams for channels produced by the encoding unit, without change, or combining the bitstreams for channels into a single bitstream and outputting the single bitstream.

7. The multi-channel video encoding apparatus adopting a space division system of claim 4, further comprising a bitstream distributor for extracting bitstreams for channels on the basis of the boundary information between channels included in a single bitstream produced by the encoding unit and outputting the bitstreams for channels.

8. The multi-channel video encoding apparatus adopting a space division system of claim 7, wherein the boundary information between channels is a slice_start_code, and the bitstream distributor sets a macro_block_increment value as 1 at every start point of the boundary of adjacent slices each having the slice_start_code.

9. The multi-channel video encoding apparatus adopting a space division system of claim 4, wherein distortion of a picture is prevented by obtaining a differential picture between macroblocks through comparison of corresponding channel video signals on the basis of the boundary information between channels included in the single bitstream produced by the encoding unit.

10. The multi-channel video encoding apparatus adopting a space division system of claim 4, wherein distortion of a picture is prevented by limiting the motion search area to the picture for an individual channel video signal in order not to search for a motion by crossing over the boundaries of pictures for video signals during motion estimation, on the basis of the boundary information between channels included in a single bitstream produced by the encoding unit.

11. A multi-channel video encoding method comprising:
extracting synchronous signals and active video data from received video signals;
spatially decimating the extracted active video data according to the number of channels to be multiprocessed;
synchronizing and serializing the decimated active video data for channels; and
sequentially encoding the decimated active video data for channels.

12. A recording medium readable by a computer to which a program for executing the method of claim 11 is written.

13. A hybrid multi-channel video encoding method comprising:
generating a newly synchronized video signal i.e. the 1^{st} signlal comprising of spatially decimated input videos;
generating a frame switched serial video signal i.e. 2^{nd} signal without frame delay, that is, temporally divided input videos;
encoding selectively the 1^{st} or 2^{nd} signal.

14. The A hybrid multi-channel video encoding method of claim 7, further comprising a step for accepting unlimited number of input serial videos from external frame switcher, and supplying their independent bitstreams and channel information by increasing external SDRAMs.
